(19) United States
(12) Patent Application Publication
(10) Pub. No.: US 2026/0031564 A1
(43) Pub. Date: Jan. 29, 2026

(54) ELECTRIC WIRE WITH CONNECTOR, AND ELECTRIC WIRE WITH CONNECTOR MANUFACTURING METHOD

(71) Applicant: Yazaki Corporation, Tokyo (JP)

(72) Inventors: Yuya NAKANO, Shizuoka (JP); Shinji Nushima, Shizuoka (JP)

(73) Assignee: Yazaki Corporation, Tokyo (JP)

(21) Appl. No.: 19/264,135

(22) Filed: Jul. 9, 2025

(30) Foreign Application Priority Data
Jul. 29, 2024 (JP) 2024-122051

(51) Int. Cl. H01R 13/46; H01R 43/18

(52) U.S. Cl. CPC H01R 13/46; H01R 43/18

(57) ABSTRACT

An electric wire with connector includes a connector, an electric wire inserted into an under-neck portion of the connector, and a covering portion formed by a tape wound around the under-neck portion and the electric wire. The covering portion includes a first winding portion in which the tape is wound around the under-neck portion, a second winding portion in which the tape is wound around the electric wire or an exterior material through which the electric wire is inserted, a cross-winding portion in which the tape is stretched between the first winding portion and the second winding portion to intersect the electric wire, and a wrap-winding portion in which the tape is wrap-wound over or under the cross-winding portion.

### CROSS-REFERENCE TO RELATED APPLICATIONS

This application is based on and claims priority under 35 USC 119 from Japanese Patent Application No. 2024-122051 filed on Jul. 29, 2024, the entire content of which is incorporated herein by reference.

### TECHNICAL FIELD

The present disclosure relates to an electric wire with connector and an electric wire with connector manufacturing method.

### BACKGROUND ART

As an electric wire with connector, an electric wire with connector including an interposition portion formed by winding a tape around a plurality of electric wires and a covering portion formed by spirally winding the tape around an outer periphery of the interposition portion is known as disclosed in JP2016-201331A. The interposition portion is provided to reduce a force with which the tape constituting the covering portion presses the electric wire.

In the electric wire with connector described in JP2016-201331A, to prevent the tape constituting the covering portion from being displaced due to a step between a connector under-neck and the interposition portion, a wrap width of the tape constituting the covering portion needs to be increased to ⅔ or more of a tape width. In this case, the number of work steps required for winding the tape increases, and an amount of tape used also increases.

The present disclosure has been made in view of the above circumstances, and an object thereof is to provide an electric wire with connector and an electric wire with connector manufacturing method, which can prevent a tape wound around a connector under-neck and an electric wire from being displaced and can limit an increase in the number of work steps and an increase in an amount of tape used.

### SUMMARY OF INVENTION

According to the present disclosure, an electric wire with connector includes a connector, an electric wire inserted into an under-neck portion of the connector, and a covering portion formed by a tape wound around the under-neck portion and the electric wire. The covering portion includes a first winding portion in which the tape is wound around the under-neck portion, a second winding portion in which the tape is wound around the electric wire or an exterior material through which the electric wire is inserted, a cross-winding portion in which the tape is stretched between the first winding portion and the second winding portion to intersect the electric wire, and a wrap-winding portion in which the tape is wrap-wound over or under the cross-winding portion.

According to the present disclosure, an electric wire with connector manufacturing method, the electric wire with connector including a connector, an electric wire inserted into an under-neck portion of the connector, and a covering portion formed by a tape wound around the under-neck portion and the electric wire, the method includes a process of forming a first winding portion by winding the tape around the under-neck portion, a process of forming a second winding portion by winding the tape around the electric wire or an exterior material through which the electric wire is inserted, a process of forming a cross-winding portion by stretching the tape between the under-neck portion and the electric wire to intersect the electric wire, and a process of forming a wrap-winding portion by wrap-winding the tape over or under the cross-winding portion.

According to the present disclosure, the tape wound around the connector under-neck and the electric wire can be prevented from being displaced, and an increase in the number of work steps and an increase in the amount of tape used can be limited.

### BRIEF DESCRIPTION OF DRAWINGS

FIG. 1 is a front view illustrating an electric wire with connector according to an embodiment of the present disclosure;

FIG. 2 is a front view illustrating a manufacturing process of the electric wire with connector illustrated in FIG. 1;

FIG. 3 is a front view illustrating the manufacturing process of the electric wire with connector illustrated in FIG. 1;

FIG. 4 is a front view illustrating the manufacturing process of the electric wire with connector illustrated in FIG. 1;

FIG. 5 is a front view illustrating the manufacturing process of the electric wire with connector illustrated in FIG. 1;

FIG. 6 is a front view illustrating the manufacturing process of the electric wire with connector illustrated in FIG. 1;

FIG. 7 is a front view illustrating a manufacturing process of an electric wire with connector according to a comparative example;

FIG. 8 is a front view illustrating a modification of the manufacturing process of the electric wire with connector illustrated in FIG. 1;

FIG. 9 is a front view illustrating a manufacturing process of an electric wire with connector according to another embodiment of the present disclosure;

FIG. 10 is a front view illustrating a manufacturing process of an electric wire with connector according to another embodiment of the present disclosure; and

FIG. 11 is a front view illustrating the manufacturing process of the electric wire with connector illustrated in FIG. 10.

### DESCRIPTION OF EMBODIMENTS

Hereinafter, the present disclosure will be described with reference to preferred embodiments. The present disclosure is not limited to the embodiments to be described below, and the embodiments to be described below can be appropriately changed within a scope not departing from the spirit of the present disclosure. In the embodiments to be described below, a part of configurations may be not described or illustrated in the drawings, and regarding details of the omitted techniques, publicly known or well-known techniques will be appropriately applied as long as there is no contradiction with the contents to be described below.

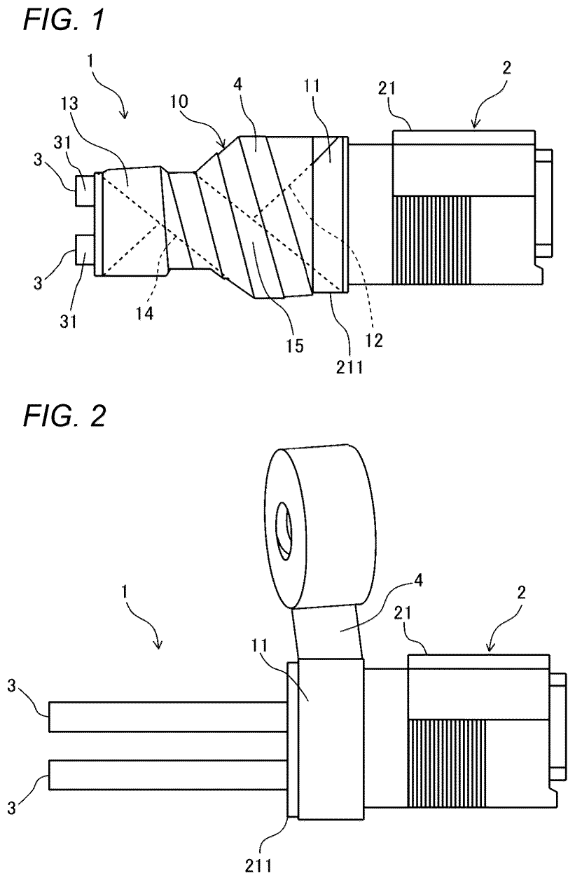

FIG. 1 is a front view illustrating an electric wire with connector 1 according to an embodiment of the present disclosure. The electric wire with connector 1 illustrated in this figure includes a connector 2, a plurality of electric wires 3, and a tape 4. The connector 2 includes a housing 21 in which a plurality of cavities (not illustrated) that accommodate terminals (not illustrated) crimped to ends of the electric wires 3 are formed. The housing 21 is fitted to a housing (not illustrated) of a mating connector (not illustrated). In a state in which the housing and the housing 21 are fitted to each other, terminals of the electric wires 3 and terminals (not illustrated) provided in the mating connector are electrically connected to each other.

The housing 21 includes a cylindrical under-neck portion 211. The under-neck portion 211 includes a circular surface provided with an insertion port for the electric wires 3 and a circular outer peripheral surface. It is not essential that the under-neck portion 211 has a cylindrical shape, and the shape of the under-neck portion 211 may be any shape around which the tape 4 can be wound (for example, a rectangular parallelepiped shape).

The electric wire 3 includes a conductive core wire (not illustrated) and an insulative coating 31 that covers the core wire. At an end of the electric wire 3, the core wire is exposed from the coating 31, and the terminal is crimped to the exposed portion of the core wire. Although FIG. 1 illustrates an example in which two electric wires 3 are arranged side by side in a left-right direction (upper-lower direction in the figure), three or more electric wires 3 may be arranged side by side in the left-right direction and an upper-lower direction (front-rear direction in the figure).

The tape 4 is a nonwoven tape, a polyvinyl chloride (PVC) tape, or the like, is wound around the under-neck portion 211 of the housing 21 and the plurality of electric wires 3, and forms a covering portion 10 that covers the under-neck portion 211 and vicinities of the ends of the plurality of electric wires 3. The covering portion 10 is formed by one piece of the tape 4, and includes an under-neck winding portion 11, a first cross-winding portion 12, an electric wire winding portion 13, a second cross-winding portion 14, and a wrap-winding portion 15.

The under-neck winding portion 11 is formed by winding the tape 4 twice around the under-neck portion 211. The first cross-winding portion 12 is formed by obliquely stretching the tape 4, extending from a leading end of the under-neck winding portion 11, from the under-neck winding portion 11 to the plurality of electric wires 3 to intersect the electric wires 3. The electric wire winding portion 13 is formed by winding the tape 4, extending from a leading end of the first cross-winding portion 12, twice around the plurality of electric wires 3. The second cross-winding portion 14 is formed by obliquely stretching the tape 4, extending from a leading end of the electric wire winding portion 13, from the electric wire winding portion 13 to the under-neck winding portion 11 to intersect the electric wires 3. The wrap-winding portion 15 is formed by spirally wrap-winding the tape 4, extending from a leading end of the second cross-winding portion 14, around the under-neck winding portion 11, the first cross-winding portion 12, the second cross-winding portion 14, and the electric wire winding portion 13.

The first cross-winding portion 12 is obliquely stretched from an upper side of the under-neck portion 211 in the figure to the lower left in the figure, whereas the second cross-winding portion 14 is obliquely stretched from an upper side of the electric wire winding portion 13 in the figure to the lower right in the figure. That is, when viewed in the front-rear direction in the figure, the first cross-winding portion 12 and the second cross-winding portion 14 intersect each other.

A wrap width of the wrap-winding portion 15 (overlapping width of the adjacent tapes 4) is ½ of a width of the tape 4. The wrap-winding portion 15 is formed by half-wrap winding of the tape 4. Although it is not essential to set the wrap width of the wrap-winding portion 15 to ½ of the width of the tape 4, the wrap width of the wrap-winding portion 15 is preferably less than ⅔ of the width of the tape 4 and more preferably ½ or less of the width of the tape 4 from a viewpoint of further reducing an amount of the tape 4 used.

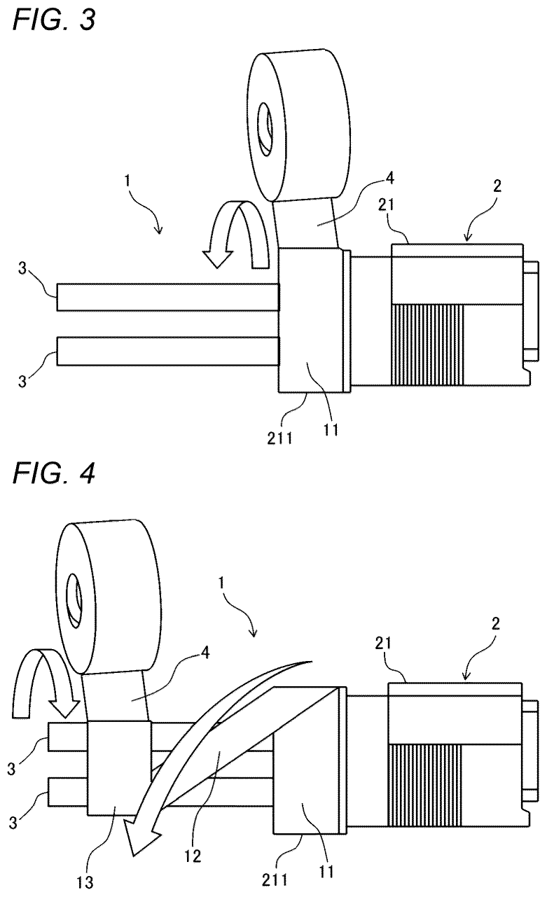

FIGS. 2 to 5 are front views illustrating a manufacturing process of the electric wire with connector 1 illustrated in FIG. 1. As illustrated in FIGS. 2 and 3, first, the tape 4 is wound twice around the under-neck portion 211, thereby forming the under-neck winding portion 11. The width of the tape 4 is narrower than a width of the outer peripheral surface of the under-neck portion 211.

As illustrated in FIG. 2, the tape 4 is wound once around the under-neck portion 211, and then, as illustrated in FIG. 3, the tape 4 is inclined toward the electric wires 3 (left side in the figure) and wound around the under-neck portion 211. Next, as illustrated in FIG. 4, the tape 4 extending from the leading end of the under-neck winding portion 11 is obliquely stretched from the under-neck winding portion 11 to the plurality of electric wires 3, thereby forming the first cross-winding portion 12. Next, the tape 4 extending from the leading end of the first cross-winding portion 12 is wound twice around the plurality of electric wires 3, thereby forming the electric wire winding portion 13.

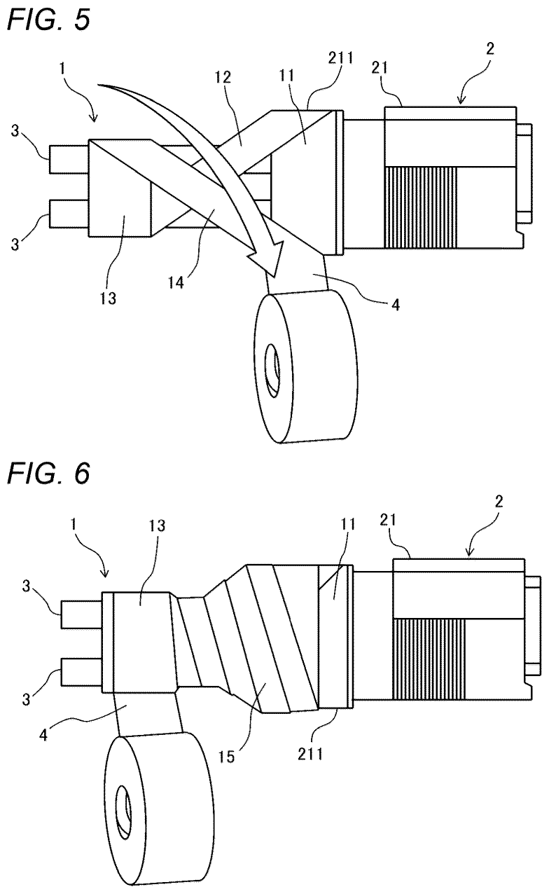

Next, as illustrated in FIG. 5, the tape 4 extending from the leading end of the electric wire winding portion 13 is obliquely stretched from the electric wire winding portion 13 to the under-neck winding portion 11, thereby forming the second cross-winding portion 14. At this time, the second cross-winding portion 14 is obliquely stretched such that the first cross-winding portion 12 and the second cross-winding portion 14 intersect each other.

Next, as illustrated in FIG. 6, the tape 4 extending from the leading end of the second cross-winding portion 14 is spirally wrap-wound over the under-neck winding portion 11, the first cross-winding portion 12, the second cross-winding portion 14, and the electric wire winding portion 13, thereby forming the wrap-winding portion 15. In the present embodiment, the wrap-winding portion 15 is formed by half-wrap winding of the tape 4.

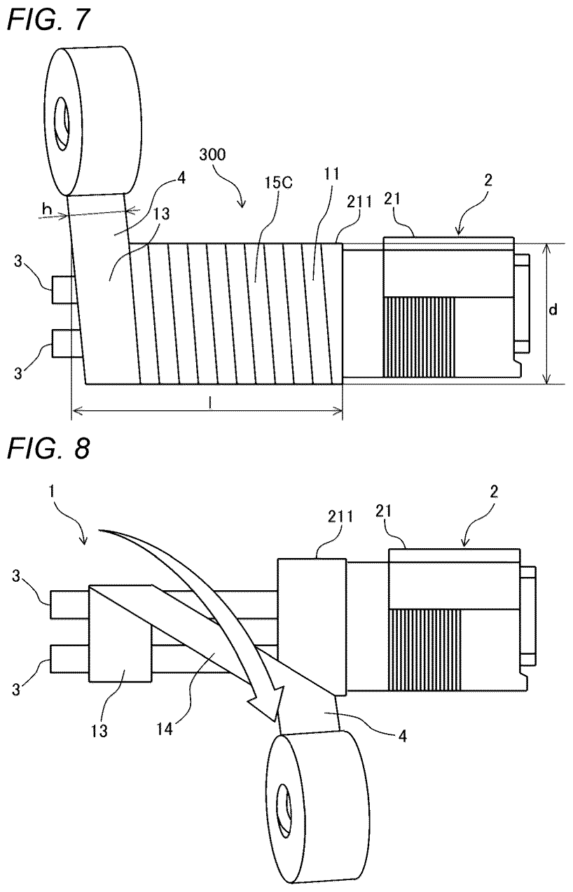

FIG. 7 is a front view illustrating a manufacturing process of an electric wire with connector 300 according to a comparative example. As illustrated in this figure, in the manufacturing process of the electric wire with connector 300 according to the comparative example, the tape 4 is wound twice around the under-neck portion 211, thereby forming the under-neck winding portion 11, and then the tape 4 extending from the leading end of the under-neck winding portion 11 is wrap-wound around the under-neck winding portion 11 and the plurality of electric wires 3, thereby forming a wrap-winding portion 15C. Then, the tape 4 extending from a leading end of the wrap-winding portion 15C is wound twice around the plurality of electric wires 3, thereby forming the electric wire winding portion 13.

In the manufacturing process of the electric wire with connector 300 according to the comparative example, a wrap width of the wrap-winding portion 15C is set to ⅔ of a width h of the tape 4 from a viewpoint of preventing displacement of the tape 4. Hereinafter, the amount of the tape 4 used in the electric wire with connector 300 according to the comparative example and the electric wire with connector 1 according to the above embodiment will be examined.

When the width h of the tape 4 is 19 mm, a length 1 of a section around which the tape 4 is wound is 60 mm, and a diameter d of the cylindrical under-neck portion 211 is 30 mm, the amount of the tape 4 used is 1268 mm in the manufacturing process of the electric wire with connector 300 according to the comparative example, as illustrated in the following equation (1).

$$Amount of tape 4 used = under - neck winding portion 11 + wrap - winding portion 15 C + electric wire winding portion 13 = ( d \times π \times 2 ) + \{ ( d \times π \times 1 ) / ( h / 3 ) \} + ( d \times π \times 2 ) = ( 30 \times π \times 2 ) + \{ ( 30 \times π \times 60 ) / ( 19 / 3 ) \} + ( 30 \times π \times 2 ) = 1268 mm \qquad ( 1 )$$

On the other hand, when the width h of the tape 4, the length 1 of the section, and the diameter d of the cylindrical under-neck portion 211 are set to the same conditions, the amount of the tape 4 used is 1105 mm in the manufacturing process of the electric wire with connector 1 according to the above embodiment, as illustrated in the following equation (2).

$$Amount of tape 4 used = under - neck winding portion 11 + first cross - winding portion 12 + electric wire winding portion 13 + second cross - winding portion 14 + wrap - winding portion 15 = ( d \times π \times 2 ) + √ ( {l}^{2} + {d}^{2} ) + ( d \times π \times 2 ) + √ ( {l}^{2} + {d}^{2} ) + \{ ( d \times π \times 1 ) / ( h / 2 ) \} = ( 30 \times π \times 2 ) + √ ( {60}^{2} + 3 {0}^{2} ) + ( 30 \times π \times 2 ) + √ ( {60}^{2} + 3 {0}^{2} ) + \{ ( 30 \times π \times 60 ) / ( 19 / 2 ) \} = 1105 mm \qquad ( 2 )$$

As described above, in the electric wire with connector 1 according to the present embodiment, in the covering portion 10, the under-neck winding portion 11 is formed by winding the tape 4 around the under-neck portion 211, the electric wire winding portion 13 is formed by winding the tape 4 around the electric wires 3, the first cross-winding portion 12 and the second cross-winding portion 14 are formed by stretching the tape 4 between the under-neck winding portion 11 and the electric wire winding portion 13 to intersect the electric wires 3, and the wrap-winding portion 15 is formed by wrap-winding the tape 4 over the first cross-winding portion 12 and the second cross-winding portion 14.

According to the electric wire with connector 1 according to the present embodiment, the tape 4 forming the first cross-winding portion 12 and the second cross-winding portion 14 intersects the electric wires 3 between the under-neck portion 211 and the electric wires 3 in a stretched state. Accordingly, the wrap-winding portion 15 can be formed by wrap-winding the tape 4 in a state in which a step between the under-neck portion 211 and the electric wires 3 is eliminated. Therefore, displacement of the tape 4 in the wrap-winding portion 15 can be prevented. Further, since the displacement of the tape 4 in the wrap-winding portion 15 can be prevented, there is no need to increase the width of the tape 4 beyond what is needed, and thus an increase in the number of steps required for the work of winding the tape 4 and an increase in the amount of the tape 4 used can be limited.

In the electric wire with connector 1 according to the present embodiment, the first cross-winding portion 12 and the second cross-winding portion 14 are stretched between the under-neck portion 211 and the electric wires 3 to intersect each other. Accordingly, the effect of eliminating the step between the under-neck portion 211 and the electric wires 3 is enhanced, and the effect of preventing the tape 4 from being displaced in the wrap-winding portion 15 is enhanced.

In the electric wire with connector 1 according to the present embodiment, the covering portion 10 is formed by winding one piece of the tape 4 around the under-neck portion 211 and the electric wires 3. Accordingly, only one piece of the tape 4 to be wound around the under-neck portion 211 and the electric wires 3 is sufficient, and the tape 4 can be continuously wound twice around the under-neck portion 211 and then wrap-wound. Therefore, since there is no need to separately prepare a tape for cross-winding and a tape for wrap-winding or to separately perform a cross-winding process and a wrap-winding process, management of materials and processes can be facilitated.

An electric wire with connector 1 manufacturing method according to the present embodiment includes: a process of forming the under-neck winding portion 11 by winding the tape 4 around the under-neck portion 211, a process of forming the electric wire winding portion 13 by winding the tape 4 around the electric wires 3, a process of forming the first cross-winding portion 12 and the second cross-winding portion 14 by stretching the tape 4 between the under-neck winding portion 11 and the electric wires 3 to intersect the electric wires 3, and a process of forming the wrap-winding portion 15 by wrap-winding the tape 4 over the first cross-winding portion 12 and the second cross-winding portion 14.

According to the electric wire with connector 1 manufacturing method according to the present embodiment, the tape 4 forming the first cross-winding portion 12 and the second cross-winding portion 14 is made to intersect the electric wires 3 between the under-neck portion 211 and the electric wires 3 in a stretched state. Accordingly, the wrap-winding portion 15 can be formed by wrap-winding the tape 4 in a state in which the step between the under-neck portion 211 and the electric wires 3 is eliminated. Therefore, the displacement of the tape 4 in the wrap-winding portion 15 can be prevented. Further, since the displacement of the tape 4 in the wrap-winding portion 15 can be prevented, there is no need to increase the width of the tape 4 beyond what is needed, and thus an increase in the number of steps required for the work of winding the tape 4 and an increase in the amount of the tape 4 used can be limited.

In the electric wire with connector 1 manufacturing method according to the present embodiment, the process of forming the first cross-winding portion 12 is performed after performing the process of forming the under-neck winding portion 11, and the process of forming the electric wire winding portion 13 is performed after the process of forming the first cross-winding portion 12 is performed. Accordingly, the first cross-winding portion 12 can be maintained in a stretched state between the under-neck winding portion 11 and the electric wire winding portion 13.

In the electric wire with connector 1 manufacturing method according to the present embodiment, a second process of forming the second cross-winding portion 14 is performed after sequentially performing the process of forming the under-neck winding portion 11, the process of forming the first cross-winding portion 12, and a first process of forming the electric wire winding portion 13. At this time, the tape 4 is stretched to intersect each other between the under-neck portion 211 and the electric wires 3. Accordingly, the effect of eliminating the step between the under-neck portion 211 and the electric wires 3 is enhanced, and the effect of preventing the tape 4 from being displaced in the wrap-winding portion 15 is enhanced.

In the electric wire with connector 1 manufacturing method according to the present embodiment, the covering portion 10 is formed by winding one piece of the tape 4 around the under-neck portion 211 and the electric wires 3. That is, one piece of the tape 4 is continuously wound around the under-neck portion 211, starting with being wound twice and proceeding to wrap-winding. Therefore, since there is no need to separately prepare a tape for cross-winding and a tape for wrap-winding or to separately perform a cross-winding process and a wrap-winding process, management of materials and processes can be facilitated.

FIG. 8 is a front view illustrating a modification of the manufacturing process of the electric wire with connector 1 illustrated in FIG. 1. As illustrated in this figure, the tape 4 is wound twice around the plurality of electric wires 3, thereby forming the electric wire winding portion 13, and then the tape 4 extending from the leading end of the electric wire winding portion 13 is obliquely stretched from the electric wire winding portion 13 to the under-neck portion 211 to intersect the electric wires 3, thereby forming the second cross-winding portion 14. Then, the tape 4 extending from the leading end of the second cross-winding portion 14 is wound twice around the under-neck portion 211, thereby forming the under-neck winding portion 11, and then the tape 4 extending from the leading end of the under-neck winding portion 11 is obliquely stretched to the electric wire winding portion 13, thereby forming the first cross-winding portion 12 (not illustrated). Then, the tape 4 extending from the leading end of the first cross-winding portion 12 is wrap-wound around the electric wire winding portion 13, the second cross-winding portion 14, the first cross-winding portion 12, and the under-neck winding portion 11, thereby forming the wrap-winding portion 15 (not illustrated).

As described above, in the electric wire with connector 1 manufacturing method according to the modification, the process of forming the second cross-winding portion 14 is performed after performing the process of forming the electric wire winding portion 13, and then the process of forming the under-neck winding portion 11 is performed. Accordingly, the second cross-winding portion 14 can be maintained in a stretched state between the electric wire winding portion 13 and the under-neck winding portion 11.

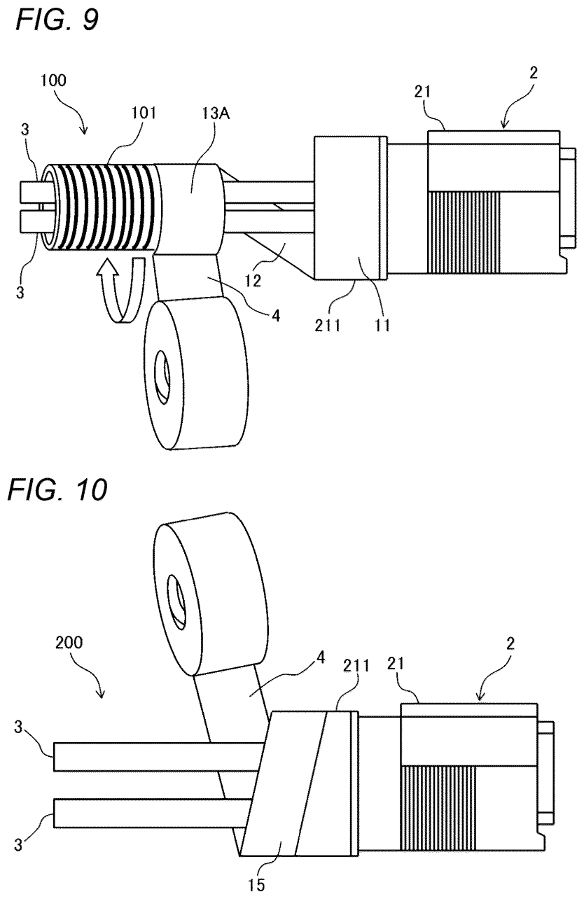

FIG. 9 is a front view illustrating a manufacturing process of an electric wire with connector 100 according to another embodiment of the present disclosure. The electric wire with connector 100 illustrated in this figure includes an exterior material 101 through which the plurality of electric wires 3 are inserted. In the present embodiment, the exterior material 101 is a corrugated tube.

As illustrated in FIG. 9, the tape 4 is wound twice around the under-neck portion 211, thereby forming the under-neck winding portion 11, and then the tape 4 extending from the leading end of the under-neck winding portion 11 is obliquely stretched from the under-neck winding portion 11 to the exterior material 101 to intersect the electric wires 3, thereby forming the first cross-winding portion 12. Then, the tape 4 extending from the leading end of the first cross-winding portion 12 is wound twice around the exterior material 101, thereby forming an exterior material winding portion 13A. Then, the tape 4 extending from a leading end of the exterior material winding portion 13A is obliquely stretched from the exterior material winding portion 13A to the under-neck winding portion 11 to intersect the electric wires 3, thereby forming the second cross-winding portion 14, and then the tape 4 extending from the leading end of the second cross-winding portion 14 is wrap-wound around the under-neck winding portion 11, the first cross-winding portion 12, the second cross-winding portion 14, and the exterior material winding portion 13A, thereby forming the wrap-winding portion 15 (not illustrated).

As described above, in the electric wire with connector 100 according to the present embodiment, in the covering portion 10, the under-neck winding portion 11 is formed by winding the tape 4 around the under-neck portion 211, the exterior material winding portion 13A is formed by winding the tape 4 around the exterior material 101, the first cross-winding portion 12 and the second cross-winding portion 14 are formed by stretching the tape 4 between the under-neck winding portion 11 and the exterior material winding portion 13A to intersect the electric wires 3, and the wrap-winding portion 15 is formed by wrap-winding the tape 4 over the first cross-winding portion 12 and the second cross-winding portion 14.

According to the electric wire with connector 100 according to the present embodiment, the tape 4 forming the first cross-winding portion 12 and the second cross-winding portion 14 intersects the electric wires 3 between the under-neck portion 211 and the exterior material 101 in a stretched state. Accordingly, the wrap-winding portion 15 can be formed by wrap-winding the tape 4 in a state in which a step between the under-neck portion 211 and the exterior material 101 is eliminated. Therefore, the displacement of the tape 4 in the wrap-winding portion 15 can be prevented. Further, since the displacement of the tape 4 in the wrap-winding portion 15 can be prevented, there is no need to increase the width of the tape 4 beyond what is needed, and thus an increase in the number of steps required for the work of winding the tape 4 and an increase in the amount of the tape 4 used can be limited.

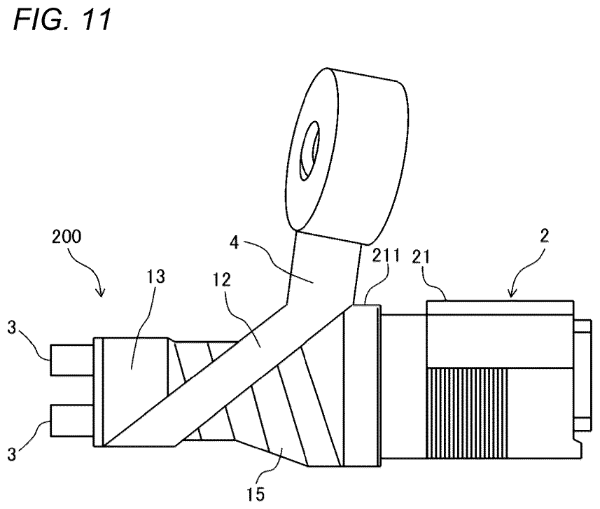

FIGS. 10 and 11 are front views illustrating a manufacturing process of an electric wire with connector 200 according to another embodiment of the present disclosure. In the electric wire with connector 200 illustrated in these figures, the first cross-winding portion 12 and the second cross-winding portion 14 are formed on the wrap-winding portion 15.

As illustrated in FIG. 10, first, the tape 4 is wrap-wound around the under-neck portion 211 and the plurality of electric wires 3, thereby forming the wrap-winding portion 15. Then, as illustrated in FIG. 11, the tape 4 extending from the leading end of the wrap-winding portion 15 is obliquely stretched from the leading end of the wrap-winding portion 15 to the under-neck portion 211 to intersect the electric wires 3, thereby forming the first cross-winding portion 12. Then, the tape 4 extending from the leading end of the first cross-winding portion 12 is wound twice around the under-neck portion 211, thereby forming the under-neck winding portion 11, and then the tape 4 extending from the leading end of the under-neck winding portion 11 is obliquely stretched from the under-neck portion 211 toward the leading end of the wrap-winding portion 15 to intersect the electric wires 3, thereby forming the second cross-winding portion 14 (not illustrated). Then, the tape 4 extending from the leading end of the second cross-winding portion 14 is wound twice around the leading end of the wrap-winding portion 15, thereby forming the electric wire winding portion 13 (not illustrated).

As described above, in the electric wire with connector 200 according to the present embodiment, in the covering portion 10, the under-neck winding portion 11 is formed by winding the tape 4 around the under-neck portion 211, the electric wire winding portion 13 is formed by winding the tape 4 around the electric wires 3, the first cross-winding portion 12 and the second cross-winding portion 14 are formed by stretching the tape 4 between the under-neck winding portion 11 and the electric wire winding portion 13 to intersect the electric wires 3, and the wrap-winding portion 15 is formed by wrap-winding the tape 4 under the first cross-winding portion 12 and the second cross-winding portion 14.

According to the electric wire with connector 200 according to the present embodiment, the tape 4 forming the first cross-winding portion 12 and the second cross-winding portion 14 intersects the electric wires 3 between the under-neck portion 211 and the electric wires 3 in a stretched state. Accordingly, after the wrap-winding portion 15 is formed, the step between the under-neck portion 211 and the electric wires 3 can be eliminated. Therefore, the displacement of the tape 4 in the wrap-winding portion 15 can be prevented. Further, since the displacement of the tape 4 in the wrap-winding portion 15 can be prevented, there is no need to increase the width of the tape 4 beyond what is needed, and thus an increase in the number of steps required for the work of winding the tape 4 and an increase in the amount of the tape 4 used can be limited.

The present disclosure has been described above based on the above embodiments, but the present disclosure is not limited to the above embodiments, and modifications may be made to the above embodiments, and publicly known or well-known techniques may be appropriately combined within a scope not departing from the spirit of the present disclosure.

For example, in the above embodiment, the first cross-winding portion 12 and the second cross-winding portion 14 are formed. However, only one of the first cross-winding portion 12 and the second cross-winding portion 14 may be formed. In addition, the under-neck winding portion 11, the electric wire winding portion 13, and the exterior material winding portion 13A are formed by winding the tape 4 twice around the under-neck portion 211, the electric wires 3, or the exterior material 101. However, the tape 4 may be wound once or more than three times.

What is claimed is:

1. An electric wire with connector, comprising:
a connector;
an electric wire inserted into an under-neck portion of the connector; and
a covering portion formed by a tape wound around the under-neck portion and the electric wire, wherein
the covering portion includes
a first winding portion in which the tape is wound around the under-neck portion,
a second winding portion in which the tape is wound around the electric wire or an exterior material through which the electric wire is inserted,
a cross-winding portion in which the tape is stretched between the first winding portion and the second winding portion to intersect the electric wire, and
a wrap-winding portion in which the tape is wrap-wound over or under the cross-winding portion.

2. The electric wire with connector according to claim 1, further comprising:
a pair of the cross-winding portions stretched to intersect each other.

3. The electric wire with connector according to claim 1, wherein
the covering portion is formed by winding one piece of the tape around the under-neck portion and the electric wire.

4. An electric wire with connector manufacturing method, the electric wire with connector including a connector, an electric wire inserted into an under-neck portion of the connector, and a covering portion formed by a tape wound around the under-neck portion and the electric wire, the method comprising:
a process of forming a first winding portion by winding the tape around the under-neck portion;
a process of forming a second winding portion by winding the tape around the electric wire or an exterior material through which the electric wire is inserted;
a process of forming a cross-winding portion by stretching the tape between the under-neck portion and the electric wire to intersect the electric wire; and
a process of forming a wrap-winding portion by wrap-winding the tape over or under the cross-winding portion.

5. The electric wire with connector manufacturing method according to claim 4, wherein
the process of forming the cross-winding portion is performed after performing one of the process of forming the first winding portion and the process of forming the second winding portion, and the other of the process of forming the first winding portion and the process of forming the second winding portion is performed after performing the process of forming the cross-winding portion.

6. The electric wire with connector manufacturing method according to claim 5, wherein
the process of forming the cross-winding portion includes
a first process of forming the cross-winding portion after performing the one of the process of forming the first winding portion and the process of forming the second winding portion, and
a second process of forming the cross-winding portion after performing the other of the process of forming the first winding portion and the process of forming the second winding portion, and
a pair of the cross-winding portions are formed by stretching the tape between the under-neck portion and the electric wire to intersect each other.

7. The electric wire with connector manufacturing method according to claim 4, wherein
the covering portion is formed by winding one piece of the tape around the under-neck portion and the electric wire.
